(19) United States
(12) Patent Application Publication
(10) Pub. No.: US 2014/0333144 A1
(43) Pub. Date: Nov. 13, 2014

(54) CONTROL APPARATUS, WIRELESS POWER TRANSMISSION SYSTEM AND WIRELESS POWER TRANSMISSION APPARATUS

(71) Applicant: Kabushiki Kaisha Toshiba, Tokyo (JP)

(72) Inventors: Katsuyuki IKEUCHI, Kawasaki-Shi (JP); Kohei ONIZUKA, Tokyo (JP); Hiroaki ISHIHARA, Kawasaki-Shi (JP); Hiroki KUDO, Kawasaki-Shi (JP); Shoji OOTAKA, Yokohama-Shi (JP); Kenichirou OGAWA, Kawasaki-Shi (JP); Fumi MORITSUKA, Kawasaki-Shi (JP)

(21) Appl. No.: 14/206,937

(22) Filed: Mar. 12, 2014

(30) Foreign Application Priority Data
May 7, 2013 (JP) 2013-097949

(51) Int. Cl. H01F 38/14

(52) U.S. Cl. CPC H01F 38/14
USPC 307/104

(57) ABSTRACT

According to one embodiment, there is provided a control apparatus for a first wireless power transmission apparatus and a second wireless power transmission apparatus. The first wireless power transmission apparatus includes a first inductor and an alternating-current signal source that supplies an alternating-current power to the first inductor. The second wireless power transmission apparatus includes a second inductor that receives the alternating-current power wirelessly from the first inductor. The position controller controls a phase relationship of current flowing in the first inductor and the second inductor such that attractive force or repulsive force is generated between the first and second inductors, and adjusts a relative position of the first inductor and the second inductor by use of the attractive force or the repulsive force.

### CROSS-REFERENCE TO RELATED APPLICATIONS

This application is based upon and claims the benefit of priority from Japanese Patent Application No. 2013-097949, filed May 7, 2013; the entire contents of which are incorporated herein by reference.

### FIELD

Embodiments described herein relates to a control apparatus, a wireless power transmission system and a wireless power transmission apparatus.

### BACKGROUND

In the related art, as for alignment of inductors of wireless power transmission, a direct-current (DC) is applied to the inductor for power transmission and the inductor for power reception, and the alignment is performed by the attractive force.

In the above-mentioned inductor alignment technique, it is necessary to apply the DC current during the alignment on the power transmission side and the power reception side. Therefore, both a mechanism to apply the DC current to the inductor on the power transmission side and a mechanism to apply the DC current to the inductor on the power reception side are required. Since the current is applied to both the power transmission side and the power reception side, there is a problem of consuming large power.

In another related art, there is a method of mounting a magnet on the power reception side and performing alignment. In this method, there arises a problem such as the weight and cost of the magnet and efficiency degradation at the time of power transmission. In addition, there are problems such as a decrease in the power transmission efficiency, an increase in the number of parts, an increase in weight, an increase in the calorific value and structural complication.

### BRIEF DESCRIPTION OF THE DRAWINGS

FIG. 1 is a view illustrating a wireless power transmission system according to a first embodiment;

FIG. 2 is a view illustrating configuration examples of an alternating-current signal source, a power transmission circuit and a power reception circuit;

FIG. 3 is a view illustrating other configuration examples of an alternating-current signal source, a power transmission circuit and a power reception circuit;

FIG. 4 is a view illustrating a configuration example of a frequency-variable signal source;

FIG. 5 is a view illustrating a specific configuration example of a frequency-variable signal source;

FIG. 6 is a view illustrating a phase difference between a primary side current and a secondary side current, and a force acting between an inductor for power transmission and an inductor for power reception;

FIG. 7 is a view illustrating a schematic operation flow of a mode switching unit;

FIG. 8 is a view illustrating a determination example using a photosensor;

FIG. 9 is a view to describe a magnetic resonance scheme and an electromagnetic induction scheme;

FIG. 10 is a view schematically illustrating a coupling coefficient between an inductor for power transmission and an inductor for power reception;

FIG. 11 is a view illustrating a relative value of current flowing on a power transmission side and a power reception side, respectively, as well as a current phase difference;

FIG. 12 is a view illustrating a sweep example of oscillation frequency in an alignment mode;

FIG. 13 is a flowchart of one example of operation according to a second embodiment;

FIG. 14 is a flowchart of one example of operation according to a third embodiment;

FIG. 15 is a view illustrating part of a configuration of a wireless power transmission system according to a fourth embodiment;

FIG. 16 is a view illustrating part of another configuration of a wireless power transmission system according to the fourth embodiment;

FIG. 17 is a schematic view of a wireless power transmission system according to a fifth embodiment;

FIG. 18 is a schematic view of a wireless power transmission system according to a sixth embodiment;

FIG. 19 is a schematic view of another example of a wireless power transmission system according to the sixth embodiment;

FIG. 20 is a schematic view illustrating a wireless power transmission system according to a seventh embodiment;

FIG. 21 is a schematic view of a wireless power transmission system according to an eighth embodiment;

FIG. 22 is a view illustrating a flow of one example of processing according to the eighth embodiment;

FIG. 23 is a view illustrating a flow of another example of processing according to the eighth embodiment;

FIG. 24 is a schematic view of a wireless power transmission system according to a ninth embodiment;

FIG. 25 is a schematic view of another configuration example of a wireless power transmission system according to the ninth embodiment;

FIG. 26 is a schematic view of yet another configuration example of a wireless power transmission system according to the ninth embodiment;

FIG. 27 is a schematic view of yet another configuration example of a wireless power transmission system according to the ninth embodiment;

FIG. 28 is a view illustrating a wireless power transmission system example according to a tenth embodiment;

FIG. 29 is a view illustrating a wireless power transmission system example according to an eleventh embodiment; and

FIG. 30 is a view illustrating another example of a wireless power transmission system according to the eleventh embodiment.

### DETAILED DESCRIPTION

According to one embodiment, there is provided a control apparatus for a first wireless power transmission apparatus and a second wireless power transmission apparatus.

The first wireless power transmission apparatus includes a first inductor and an alternating-current signal source that supplies an alternating-current power to the first inductor. The second wireless power transmission apparatus includes a second inductor that receives the alternating-current power wirelessly from the first inductor.

The position controller controls a phase relationship of current flowing in the first inductor and the second inductor such that attractive force or repulsive force is generated between the first and second inductors, and adjusts a relative position of the first inductor and the second inductor by use of the attractive force or the repulsive force.

In the following, embodiments will be described with reference to the drawings.

### First Embodiment

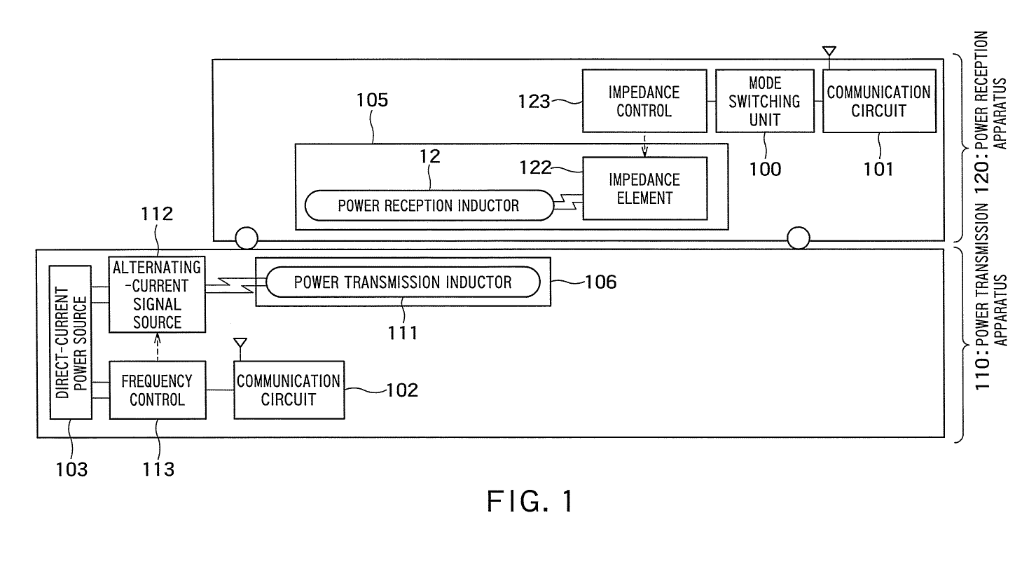

FIG. 1 illustrates a wireless power transmission system according to a first embodiment.

The wireless power transmission system in FIG. 1 includes a power transmission apparatus (wireless power transmission apparatus) 110 and a power reception apparatus (wireless power transmission apparatus) 120.

The power reception apparatus 120 includes a communication circuit 101, a mode switching unit (control apparatus) 100, an impedance controller 123 and a power reception resonator (power reception circuit) 105. The power reception resonator 105 includes a power reception inductor 12 and an impedance element 122.

The power transmission apparatus 110 includes a power transmission resonator (power transmission circuit) 106, an alternating-current signal source 112, a direct-current power source 103, a frequency controller 113 and a communication circuit 102. The power transmission resonator (power transmission circuit) 106 includes a power transmission inductor 111. The alternating-current signal source 112 generates power used at the time of an alignment mode between an inductor for power reception and an inductor for power transmission. However, the alternating-current signal source 112 may simultaneously be used as a signal source for wireless power transmission. It is assumed that the alternating-current signal source 112 is simultaneously used in the present embodiment.

Although the mode switching unit 100 is incorporated in the power reception apparatus in this example, it may be incorporated in the power transmission apparatus. Alternatively, the mode switching unit 100 may be provided as an apparatus isolated from the power transmission apparatus and the power reception apparatus.

In this example, the alternating-current signal source 112 is included in the power transmission apparatus and the impedance element 122 is included in the power reception apparatus. As another configuration, a configuration is possible where the power transmission apparatus includes the impedance element 122 instead of the alternating-current signal source 112 and the power reception apparatus includes the alternating-current signal source 112 instead of the impedance element 122. In this case, a signal source for wireless power transmission is independently arranged in the power transmission apparatus. Moreover, in this case, “power transmission inductor” and “power reception inductor” may be read as interchangeable as appropriate in the description related to the alignment mode in the following explanation.

The communication circuit 102 of the power transmission apparatus performs wireless communication with the communication circuit 101 of the power reception apparatus. The direct-current power source 103 generates direct-current power. The alternating-current signal source 112 generates alternating-current power from the direct-current power. The frequency controller 113 controls an oscillation frequency of the alternating-current signal source 112. The frequency of the alternating-current power generated by the alternating-current signal source 112 is controlled by the frequency controller 113. The power transmission inductor 111 of the power transmission circuit 106 supplies the alternating-current power supplied from the alternating-current signal source 112, to the power reception inductor 12 of the power reception circuit 105 wirelessly in a noncontact manner. It is possible to use a magnetic resonance scheme or electromagnetic induction scheme as a transmission scheme.

The communication circuit 101 of the power reception apparatus performs wireless communication with the communication circuit 102 of the power transmission apparatus. The power reception inductor 12 of the power reception circuit 105 receives the supply of power from the power transmission inductor 111 in a noncontact manner. The impedance controller 123 controls the impedance value of the impedance element 122 under control of the mode switching unit 100.

The mode switching unit 100 controls the wireless power transmission system. In a case where the mode switching unit 100 exists as a control apparatus independent from the power reception apparatus and power transmission apparatus, the control apparatus controls the power reception apparatus and the power transmission apparatus by wired communication or wireless communication.

In the present embodiment, the mode switching unit 100 switches and executes an alignment mode and a power transmission mode, as part of the above-mentioned control.

In the alignment mode, alternating-current power is applied from the alternating-current signal source 112 to the power transmission inductor 111 under a first impedance condition to perform power transmission between the power transmission inductor and the power reception inductor. At this time, the phase relationship of current that flows in both the power transmission inductor and the power reception inductor is controlled to generate the attractive force or the repulsive force. Using this, the relative position between both the inductors is adjusted. The power supplied to the power reception side may be discarded if there is no special usage on the power reception side.

The power transmission mode is executed after the alignment is completed in the alignment mode. In the power transmission mode, alternating-current power is supplied from the alternating-current signal source 112 to the power transmission inductor 111 under a second impedance condition to perform wireless power transmission from the power transmission inductor to the power reception inductor. The power supplied to the power reception side is consumed by a load or accumulated in a storage battery according to the configuration on the power reception side. The second impedance condition is an impedance condition that, for example, a resonant mode is achieved by the frequency of the alternating-current power.

As for the change in the impedance condition, various methods are possible. The impedance value of the impedance element 122 may be changed, the impedance value of the power reception circuit 105 may be changed or the oscillation frequency in the alternating-current signal source 112 may be changed. Moreover, it may be realized by a combination of these.

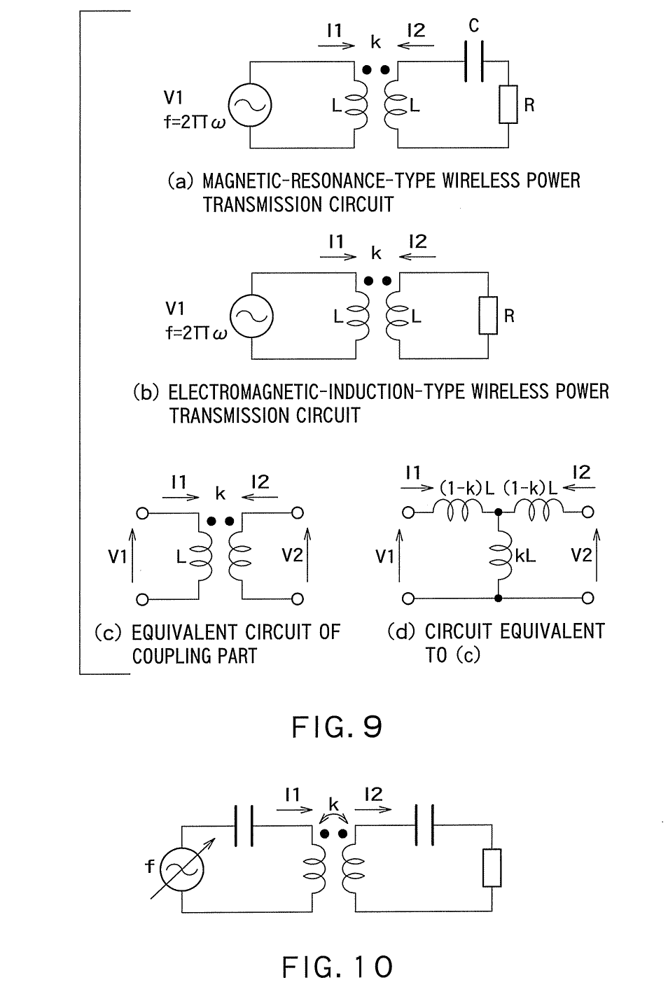

Here, the reason why the impedance condition varies (the reason why the appearance impedance with respect to a load changes) by changing the frequency of the alternating-current signal source 112 is described. FIG. 9(B) illustrates a circuit diagram of an electromagnetic-induction-type wireless power transmission circuit. This circuit has a simple circuit configuration, an inductor is connected on the power transmission side and the inductor and the load of fixed impedance are connected on the power reception side. The inductance of each of the inductors for power transmission and power reception is assumed as “L,” the value of the load is assumed as “k,” the coupling coefficient between the inductors is assumed as “R” and the angular frequency is assumed as “w.” At this time, the impedance on the power reception side can be expressed as R+jwL(1−k). Since w=2πf is established, it is understood to be able to change the impedance on the power reception side by changing frequency “f.”

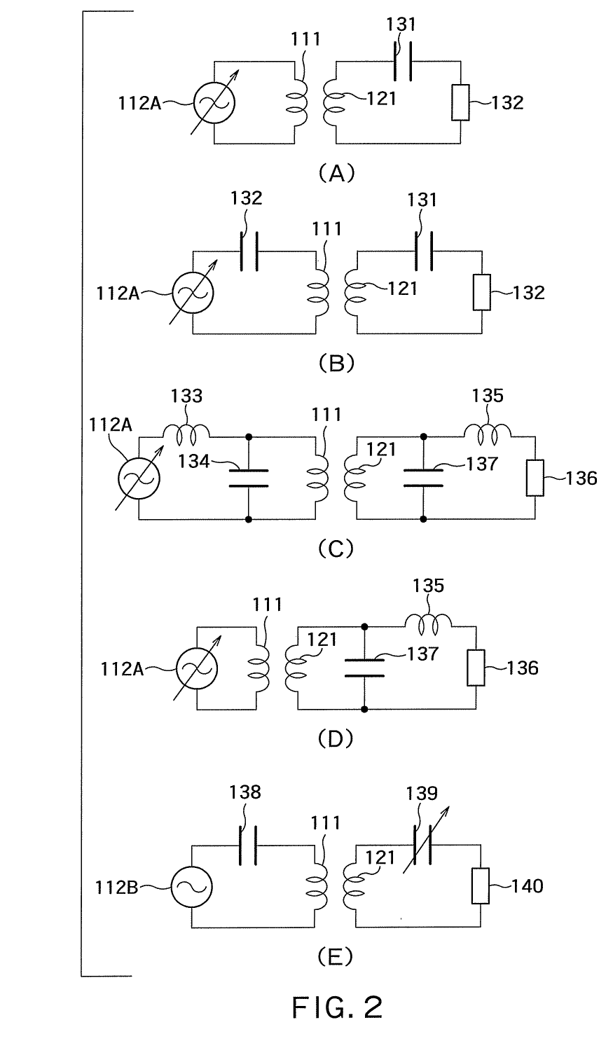

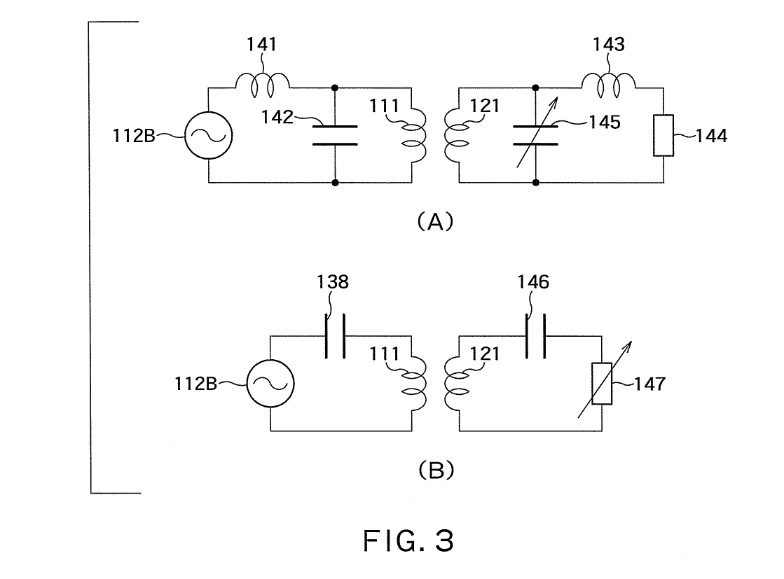

FIG. 2 and FIG. 3 illustrate configuration examples of alternating-current signal sources, power transmission circuits and power reception circuits.

In FIG. 2(A), the alternating-current signal source 112A is formed as a frequency-variable oscillation circuit (frequency-variable signal source). The power transmission circuit includes the power transmission inductor 111 connected with the alternating-current signal source. The power reception circuit includes a power reception inductor 121, a capacitor 131 and a resistance 132. In this configuration, the impedance condition is changed by changing the oscillation frequency of the alternating-current signal source 112A.

In FIG. 2(B), the resistance 132 is arranged between the alternating-current signal source 112A and the power transmission inductor 111. The power reception circuit is similar to FIG. 2(A). The impedance condition is changed by changing the oscillation frequency of the alternating-current signal source 112A.

In FIG. 2(C), an inductor 133 is directly arranged between the alternating-current signal source 112A and the power transmission inductor 111, and a power transmission capacitor 134 is arranged in parallel between them. In the power reception circuit, an inductor 135 and a resistance 136 are directly connected with the power reception inductor 121, and a capacitor 137 is arranged in parallel to the power reception inductor 121. The impedance condition is changed by changing the oscillation frequency of the alternating-current signal source 112A.

FIG. 2(D) illustrates a configuration combining the power transmission circuit in FIG. 2(A) and the power reception circuit in FIG. 2(C). The impedance condition is changed by changing the oscillation frequency of the alternating-current signal source 112A.

In FIG. 2(E), the alternating-current signal source 112B is formed as an oscillation circuit of fixed frequency. A capacitor 138 and the power transmission inductor 111 are connected in series with the alternating-current signal source 112B. In the power reception circuit, a variable capacitor 139 and a resistance 140 are connected in series with the power reception inductor 121. In this configuration, the impedance condition is changed by changing the capacitance value of the variable capacitor 139.

In FIG. 3(A), an inductor 141 is connected in series between the alternating-current signal source 112B and the power transmission inductor 111, and a capacitor 142 is arranged in parallel to the power transmission inductor 111. In the power reception circuit, an inductor 143 and a resistance 144 are directly connected with the power reception inductor 121, and a variable capacitor 145 is arranged in parallel to the power reception inductor 121. In this configuration, the impedance condition is changed by changing the capacity of the variable capacitor 145.

In FIG. 3(B), the alternating-current signal source and the power transmission circuit are the same as those in FIG. 2(E). In the power reception circuit, a capacitor 146 and a variable resistor 147 are connected with the power reception inductor 121. In this configuration, the impedance condition is changed by changing the resistance value of the variable resistor 147.

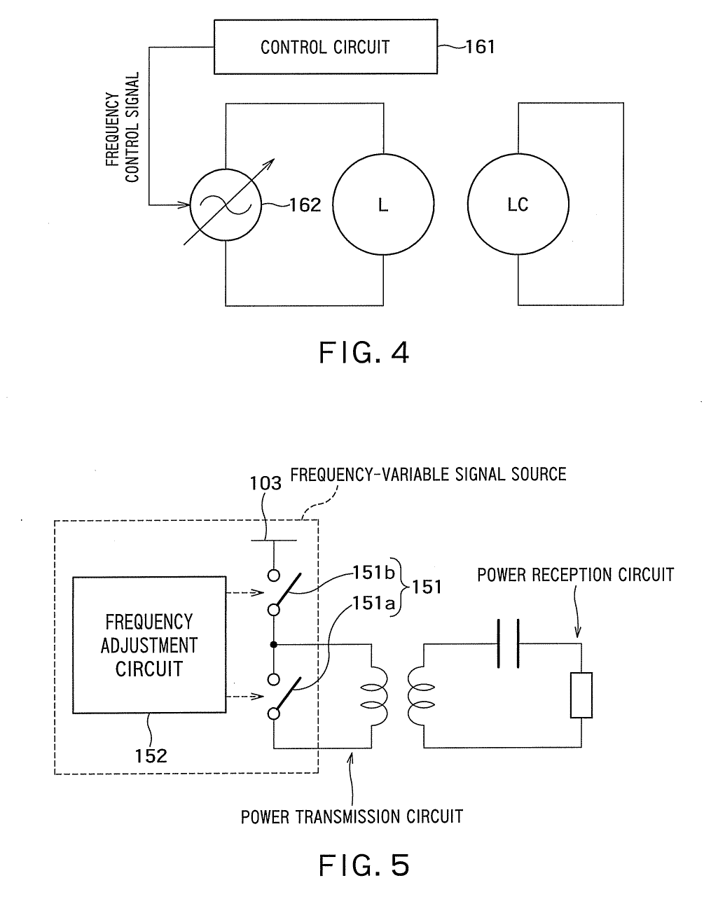

The frequency of the frequency-variable signal source 112A illustrated in FIG. 2 may be variable by giving a control signal from the outside. This configuration is schematically illustrated in FIG. 4. The frequency-variable signal source 112A includes a control circuit 161 and a frequency-variable signal source 162. A control signal is given from the control circuit 161 to the frequency-variable signal source 162. The frequency-variable signal source 162 generates alternating-current power of a frequency corresponding to the control signal.

FIG. 5 illustrates a more specific configuration example of the frequency-variable signal source 112A. The frequency-variable signal source 112A includes an inverter circuit 151 and a frequency adjustment circuit (drive signal source) 152. The frequency adjustment circuit 152 alternately performs ON/OFF control of two switches 151a and 151b of the inverter circuit 151 by a switching signal. As a result of this, alternating-current power of a variable frequency is generated on the basis of the power of the direct-current power source 103. In wireless transmission of high power, it is preferable to generate power transmission power in the inverter circuit.

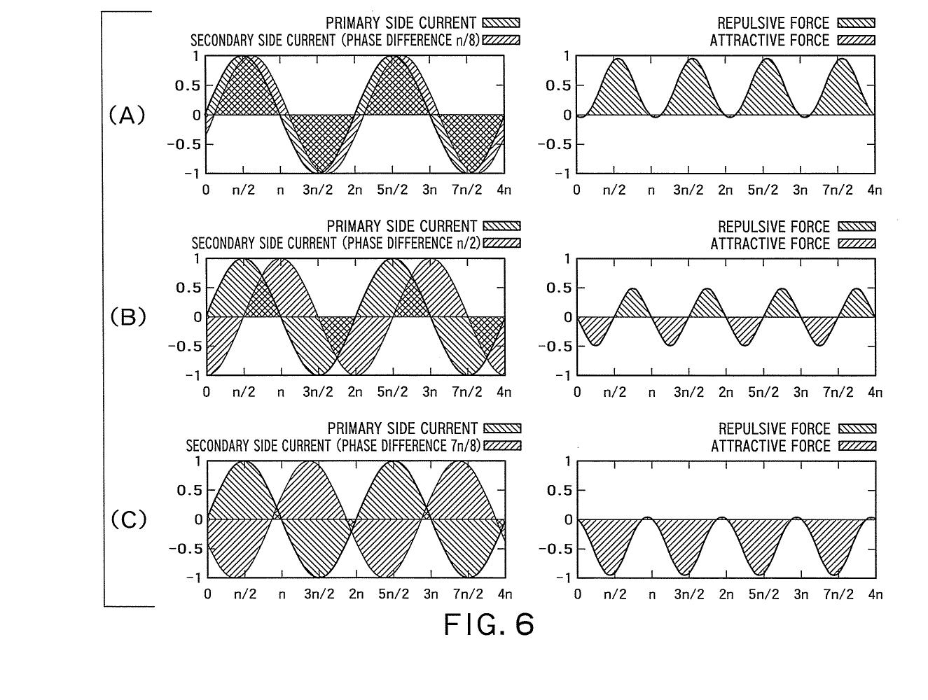

FIG. 6 illustrates the phase difference between current flowing in the power transmission inductor (primary side current) and current flowing on the power reception side (secondary side current), and the force acting between the transmission inductor and the power reception inductor (attractive force or repulsive force). Here, regarding the current directions, the direction of current flowing when a direct-current current flows in the power transmission inductor, the current value is increased and both ends of the power reception inductor are shorted, is assumed to be positive (this is similar in the following explanation).

The left of FIG. 6(B) illustrates the waveform of each current when the phase difference is π/2, and the right of FIG. 6(B) illustrates the relationship of attractive force and repulsive force generated between inductors at the time of the phase difference of FIG. 6(B). When the repulsive force and the attractive force are alternately generated in the same cycle, a state is provided in which the attractive force and the repulsive force are cancelled as a while and the force is not substantially generated between them. Such a phase difference is acquired when the frequency of alternating-current power matches the resonance frequency of the power transmission circuit and the power reception circuit or is close to this resonance frequency.

The left of FIG. 6(A) illustrates the waveform of each current when the phase difference is π/8, and the right of FIG. 6(A) illustrates the relationship of attractive force and repulsive force generated between the inductors at the time of the phase difference of FIG. 6(A). Although small attractive force is generated during ⅛th of the phase, a significant repulsive force acts between the inductors during the remaining ⅞ths of the phase. The phase difference becomes close to 0 as the frequency of the alternating-current power becomes lower than the resonance frequency, and a zone in which the repulsive force acts becomes predominant.

The left of FIG. 6(C) illustrates the waveform of each current when the phase difference is 7π/8, and the right of FIG. 6(C) illustrates the relationship of attractive force and repulsive force generated between the inductors at the time of the phase difference of FIG. 6(C). Although small repulsive force is generated during ⅛th, a significant attractive force acts between the inductors during the remaining ⅞ths of the phase. The phase difference becomes close to π as the frequency of the alternating-current power becomes higher than the resonance frequency, and a section in which the attractive force acts becomes predominant.

These states of three phase differences are realized by three different impedance conditions (frequency or impedance value). That is, the different phase differences are realized by changing the impedance condition. By flowing power from the alternating-current signal source under the impedance condition like FIG. 6(C), the attractive force is generated between the inductors and the alignment between the inductors is performed using this attractive force (for example, both inductors are mutually arranged in a short distance). Afterwards, by flowing power from the alternating-current signal source under the impedance condition like FIG. 6(B), the generation of the attractive force and the repulsive force is suppressed between the inductors, the misalignment between both inductors is suppressed and wireless power transmission is performed with high efficiency.

An explanation is given of the relationship between the current of each inductor and the force generated between the inductors. Voltage “v” induced to both ends of a second inductor of a second apparatus when current “i” flows in a first inductor of a first apparatus can be expressed as follows, using mutual inductance “M” of the first inductor and the second inductor.

$$v = M \frac{d i}{d t}$$

Here, when the absolute values of the current flowing in the first and second inductors are assumed as “I₁” and “I₂” respectively, the current phase difference of the second inductor with respect to the first inductor is assumed as “θ,” the permeability is assumed as “μ,” and the distance between the inductors is assumed as “d,” the one-period sum of force “F” acting on the unit length of the inductance of two parallel electric wires can be expressed as follows.

$$F = \frac{μ {I}_{1} {I}_{2}}{2 π d} {\int }_{0}^{2 π} sin ( x ) sin ( x + θ ) d x = \frac{μ {I}_{1} {I}_{2}}{2 d} cos ( θ )$$

Since the current that flows in the inductors is an alternating current, “F” may take a positive value and a negative value. The repulsive force is generated when the value of “F” is positive, and the attractive force is generated when it is negative. Using this force, it is possible to move the first inductor, the second inductor or both of the first and second inductors.

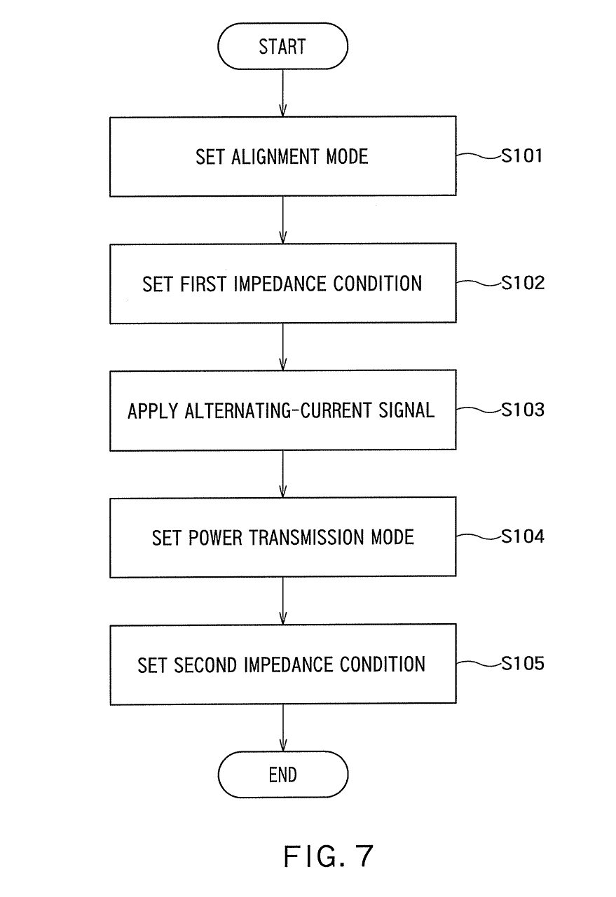

FIG. 7 illustrates one operation flow example of the mode switching unit 100. The mode switching unit 100 selects the alignment mode (S101) and sets the first impedance condition (S102). For example, the frequency or impedance value of alternating-current power is set such that the phase difference becomes a value larger than π/2 and the attractive force is generated between both inductors. The alternating-current power flows from the alternating-current signal source under this first impedance condition to generate the attractive force, and alignment is performed using this attractive force (S103). The alignment processing may be terminated after turning on electricity for a fixed time or may be terminated by detecting a desired position relationship between both inductors.

It may be determined that the position relationship between both inductors becomes a desired position relationship by an arbitrary method. For example, by estimating the positions of the inductors from a light sensor, a magnetic sensor, an electrostatic sensor or a sound sensor, it may be detected that the relative position of the inductors becomes a desired position relationship. Alternatively, it may be detected that it becomes a desired position relationship, by observing the voltage or current applied to an element such as a capacitor and a resistance in a power transmission inverter (alternating-current signal source) or resonance circuit (power reception circuit or power transmission circuit) or by observing the electric field or magnetic field generated in the inductor for power transmission or power reception.

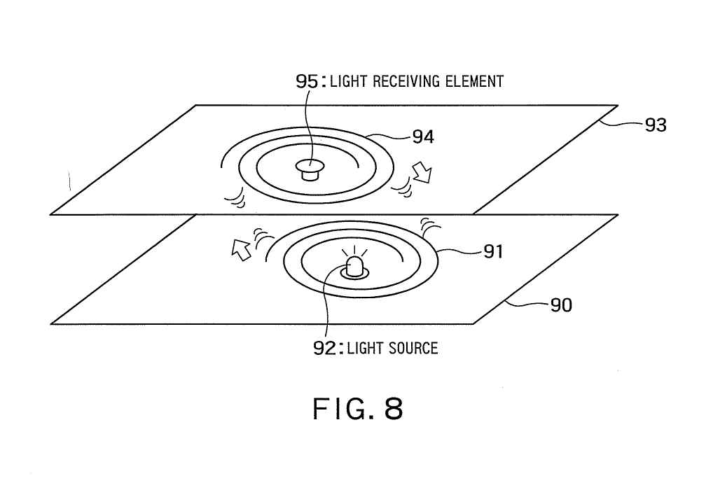

FIG. 8 illustrates an example of end determination by the use of a light sensor. For example, a light source (illuminant) 92 is arranged in part of a first inductor 91 placed in a ground plane 90, for example, in a center of the first inductor 91. The light source 92 is, for example, an LED. A light receiving element 95 is arranged in part of a second inductor 94 placed in a ground plane 93, for example, in a center of the second inductor 94.

Here, the second inductor 94 may be arranged on either an upper surface of the ground plane 93 (a surface on the opposite side to a side facing the ground plane 90) or a lower surface (the surface on a side facing the ground plane 90). In a case where it is arranged on the upper surface, the part of the ground plane 93 on which the second inductor 94 is arranged may be formed with a dielectric material or cut out. In a case where the cutout part is large, the second inductor 94 may be supported by an arbitrary method so as not to fall from the cutout part.

The light receiving element 95 is, for example, a photodiode. During the alignment mode, an illuminant 92 is set to a light-emitting state and the light receiving element 95 is set in a state in which it is possible to receive light. In a case where the light receiving element 95 detects light over a certain threshold, it is detected that it becomes a desired position relationship, and the alignment is terminated.

After the alignment ends, it switches to the power transmission mode (S104) and the second impedance condition is set (S105). For example, the frequency of alternating-current power is caused to match the resonance frequency of the power transmission circuit and the power reception circuit or become close to this resonance frequency. In this state, wireless power transmission from the power transmission apparatus to the power reception apparatus is performed.

As described above, for example, the magnetic resonance scheme or the electromagnetic induction scheme is possible as a power transmission scheme. In the following, the current phase relationship in the magnetic resonance scheme and the current phase relationship of electromagnetic induction are described.

FIG. 9(A) illustrates a circuit diagram of the magnetic-resonance-type wireless power transmission circuit and FIG. 9(B) illustrates a circuit diagram of the electromagnetic-induction-type wireless power transmission circuit. The inductance of each inductor is assumed as “L,” the coupling coefficient is assumed as “k” and the angular frequency is assumed as “ω.” Moreover, the capacitance of a series resonance capacitor on the secondary side in FIG. 9(A) is assumed as “C” and the value of the load on the secondary side is assumed as “R.” FIG. 9(C) illustrates an equivalent circuit of a coupling part of both circuits. In this equivalent circuit, the relationship between the current and voltage on the primary side and the current and voltage on the secondary side is calculated using the following Equation (1). Also, in the calculation, a circuit equivalent to FIG. 9(C) is used as illustrated in FIG. 9(D).

$$\begin{matrix}( \begin{matrix}{V}_{1} \\ {I}_{1}\end{matrix} ) = ( \begin{matrix}1 + \frac{j ω ( 1 - k ) L}{j ω kL} & j ω ( 1 - k ) L \cdot ( 2 + \frac{j ω ( 1 - k ) L}{j ω kL} ) \\ \frac{1}{j ω kL} & 1 + \frac{j ω ( 1 - k ) L}{j ω kL}\end{matrix} ) ( \begin{matrix}{V}_{2} \\ {I}_{2}\end{matrix} ) \\ = ( \begin{matrix}\frac{1}{k} & j ω \frac{1 - {k}^{2}}{k} L \\ \frac{1}{j ω kL} & \frac{1}{k}\end{matrix} ) ( \begin{matrix}{V}_{2} \\ {I}_{2}\end{matrix} )\end{matrix} \qquad ( 1 )$$

The relationship of “V₂” and “I₂” of the magnetic-resonance-type wireless power transmission system that generates series resonance on the secondary side like FIG. 9(A) is as shown by Equation (2a). The relationship of “V₂” and “I₂” in the electromagnetic-induction-type wireless power transmission apparatus like FIG. 2(B) is as shown by Equation (2b).

$$\begin{matrix}{V}_{2} = - ( \frac{1}{j ω C} + R ) {I}_{2} & ( 2 a ) \\ {V}_{2} = - {R I}_{2} & ( 2 b )\end{matrix}$$

When the relationship of “I₁” and “I₂” of the magnetic resonance scheme is calculated from Equation (2a) and the relational equation of “I₁” and “I₂” of Equation (1), Equation (3a) is acquired. Similarly, when the relationship of “I₁” and “I₂” of the electromagnetic induction scheme is calculated from Equation (2b) and the relational equation of “I₁” and “I₂” of Equation (1), Equation (3b) is acquired.

$$\begin{matrix}{I}_{1} = ( \frac{1}{k} + \frac{1}{k {ω}^{2} LC} + j \frac{R}{ω kL} ) {I}_{2} & ( 3 a ) \\ {I}_{1} = ( \frac{1}{k} + j \frac{R}{ω kL} ) {I}_{2} & ( 3 b )\end{matrix}$$

At the time of series resonance (at the time of power transmission), when

$$ω = \frac{1}{\sqrt{LC}} or Q = \frac{1}{R} \sqrt{\frac{L}{C}}$$

is set, Equation (4a) is acquired from Equation (3).

$${I}_{1} = ( \frac{2}{k} + j \frac{1}{kQ} ) {I}_{2} \qquad ( 4 a )$$

Since “kQ” is generally designed to increase in the magnetic resonance, the phase difference between “I₁” and “I₂” is close to 90 degrees (π/2). That is, in the magnetic resonance, power transmission is performed in a state where the phase difference between “I₁” and “I₂” is close to 90 degrees (m/2) (see FIG. 6). At the time of alignment, the repulsive force or the attractive force can be generated in the phase relationship illustrated in FIG. 6.

Meanwhile, since power transmission is performed in a range in which ωL is small in the electromagnetic induction, the phase difference between “I₁” and “I₂” is close to 0 degrees. That is, power transmission is performed in a state where the phase difference between “I₁” and “I₂” is close to 0 degrees in the magnetic resonance. Although the phase in which the repulsive force or the attractive force is generated is different from the one illustrated in FIG. 6, it is possible to generate the attractive force or the repulsive force by adjusting the phase difference by a similar theory to the one described using FIG. 6.

Thus, in any scheme, it is possible to change the phase difference by changing the resonance frequency or the load (impedance) and generate the attractive force and the repulsive force. Thus, the present embodiment is applicable to a power transmission scheme of an arbitrary scheme such as the magnetic resonance scheme and the electromagnetic induction scheme.

### Second Embodiment

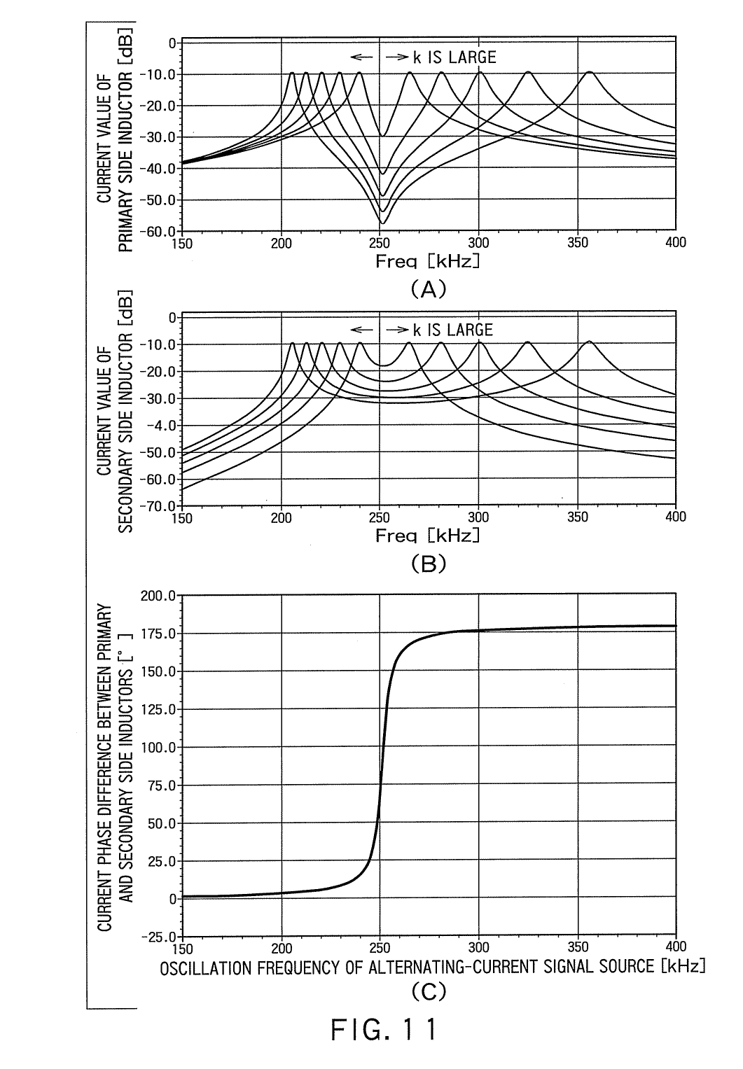

FIG. 10 schematically illustrates coupling coefficient “k” between a power transmission inductor (primary side inductor) and a power reception inductor (secondary side inductor). Moreover, FIG. 11 illustrates the relative values of current flowing on the power transmission side and the power reception side when the load impedance is made constant, the coupling coefficient is changed and the frequency of the frequency signal source is swept (FIG. 11(A) and FIG. 11(B)), and the current phase difference flowing in the power transmission inductor and the power reception inductor (FIG. 11(C)). In this example, the power reception circuit resonates at about 250 kHz.

When the coupling coefficient between the power transmission inductor and the power reception inductor is small, if an alternating-current voltage is applied to both ends of the power transmission inductor, power is transmitted most from the power transmission side to the power reception side near the resonance frequency and current flows in the inductor. When the coupling coefficient becomes large, feature points appear in a frequency lower than the resonance frequency and a frequency higher than the resonance frequency. As the coupling coefficient increases, the frequency of the feature point gets away from the resonance frequency to both sides.

Therefore, the present embodiment sets certain load impedance in a fixed manner at the time of the alignment mode and sweeps the frequency of the alternating-current signal source from a first frequency to a second frequency.

For example, when the attractive force is used, the frequency is sequentially swept from a frequency in the vicinity of the resonance frequency toward the first frequency higher than this. When the repulsive force is used, the frequency is sequentially swept from the second frequency equal to or less than the resonance frequency toward frequency in the vicinity of the resonance frequency. By such swept, it is possible to respond to the frequency movement of a feature point caused by the change in coupling coefficient “k” according to the change in the relative position of the inductors, and to use large attractive force or impulsive force. By using the differential of current becoming negative when the frequency exceeds the feature point, the sweep may be performed so as to prevent the differential value from becoming negative (so as to maintain a positive differential value). In a case where it becomes negative along the way, the sweep of frequency may be caused to wait until it becomes 0 or positive.

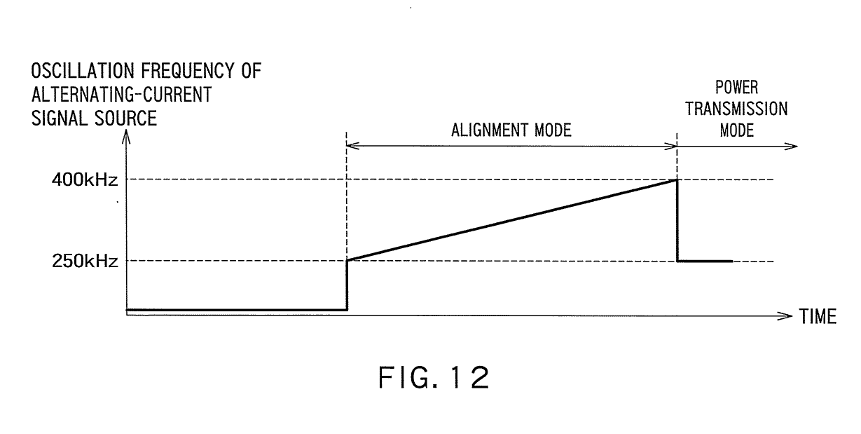

FIG. 12 illustrates an example of frequency sweep.

In a state where the load impedance value is fixed, the oscillation frequency of the alternating-current signal source is continuously swept. In the illustrated example, the oscillation frequency is swept from 250 kHz in the vicinity of the resonance frequency to 400 kHz at a constant speed. As a result of this, effective alignment is possible since the frequency as a feature point moves to a high value according to an increase in the coupling coefficient as the distance between the inductors becomes shorter. The alignment is terminated after it is swept up to 400 kHz, and it shifts to the power transmission mode. Wireless power transmission is performed at 250 kHz in the power transmission mode. Here, in the power transmission mode, the value of the load impedance may be set to a different value from the one at the time of alignment.

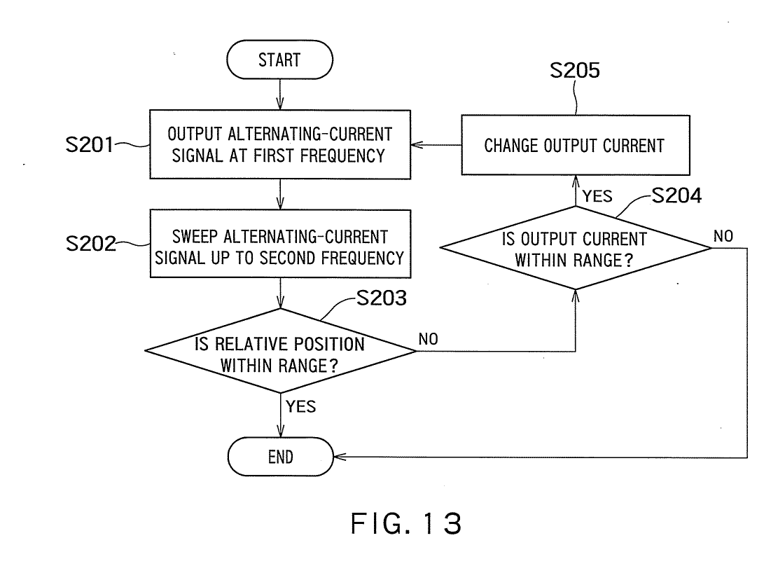

FIG. 13 is a flowchart of one example of operation according to the present embodiment.

The first frequency and the second frequency are defined in advance and the frequency-variable alternating-current signal source that can be swept between these frequencies is used. In the above-mentioned example of FIG. 12, the first frequency corresponds to 250 kHz and the second frequency corresponds to 400 kHz.

By sweeping the output of this frequency-variable signal source from the first frequency to the second frequency (S201 and S202), the relative position between the inductors is changed. The first frequency and the second frequency may be set in advance, may be decided from the inductor coupling coefficient, the current value of the first apparatus, the voltage of the second apparatus, the relative position relationship between the first apparatus and the second apparatus, the maximum voltage of the first or second apparatus or the maximum current of the first or second apparatus with reference to a comparison table, or calculated by computation. Here, the first apparatus is one of the power transmission apparatus and the power reception apparatus, and the second apparatus is the other.

When it is swept from the first frequency to the second frequency, it is determined whether the relative position between the inductors is within a desired range (S203), and, in a case where it is within the desired range, the alignment mode ends and it shifts to the power transmission mode. In a case where it is not within the desired range, it is determined whether the output current of the alternating-current signal source reaches the upper limit (S204), and, if it reaches the upper limit, the alignment mode ends. In this case, it does not have to shift to the power transmission mode. If it does not reach the upper limit, the output current is adjusted to a large value and it returns to step S201. By increasing the output current, it is possible to acquire more attractive force or repulsive force. Alternatively, in a case where the relative position is not within the desired range, the frequency may be swept at a slower speed. As a result of this, there is an advantage that the inductor becomes easy to move. A configuration is possible in which both an increase of the output current and a decrease of the sweep rate are performed.

### Third Embodiment

Although the alignment between the inductors is performed by sweeping the oscillation frequency in the second embodiment, the alignment between the inductors may be performed by sweeping the impedance value. Since the resonance frequency varies by sweeping the impedance value, it is possible to acquire an effect similar to the second embodiment.

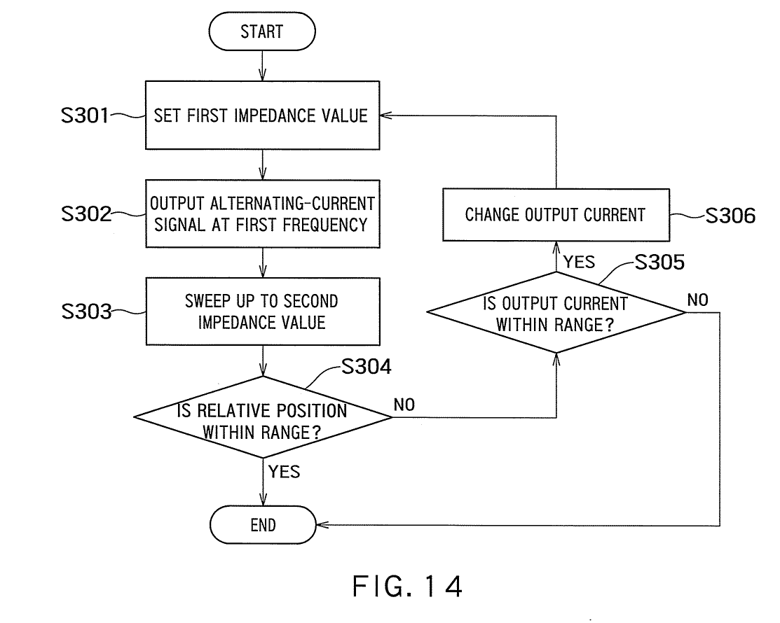

FIG. 14 is a flowchart of one example of operation according to the present embodiment.

The impedance value of an impedance element is set to a first impedance value (S301) and the alternating-current power of a first frequency is output (S302). The value of the impedance element is swept from the first impedance value to a second impedance value (S303). As a result of this, the relative position between the inductors is changed.

The first impedance value and the second impedance value may be set in advance, may be decided from the coupling coefficient between the inductors, the current value of the first apparatus, the voltage of the second apparatus, the relative position relationship between the first apparatus and the second apparatus, the maximum voltage of the first or second apparatus or the maximum current of the first or second apparatus with reference to a comparison table, or calculated by computation. Here, the first apparatus is one of the power transmission apparatus and the power reception apparatus, and the second apparatus is the other.

After the impedance value is swept from the first impedance value to the second impedance value, it is determined whether the relative position between the inductors is within a desired range (S304), and, in a case where it is within the desired range, the alignment mode ends and it shifts to the power transmission mode. In a case where it is not within the desired range, it is determined whether the output current of the alternating-current signal source reaches the upper limit (S305), and, if it reaches the upper limit, the alignment mode ends. In this case, it does not have to shift to the power transmission mode. If it does not reach the upper limit, the output current is adjusted to a large value (S306) and it returns to step S301. By increasing the output current, it is possible to acquire more attractive force or repulsive force. Alternatively, in a case where the relative position is not within the desired range, the impedance value may be swept at a slower speed. As a result of this, there is an advantage that the inductor becomes easy to move. A configuration is possible in which both an increase of the output current and a decrease of the sweep rate are performed.

### Fourth Embodiment

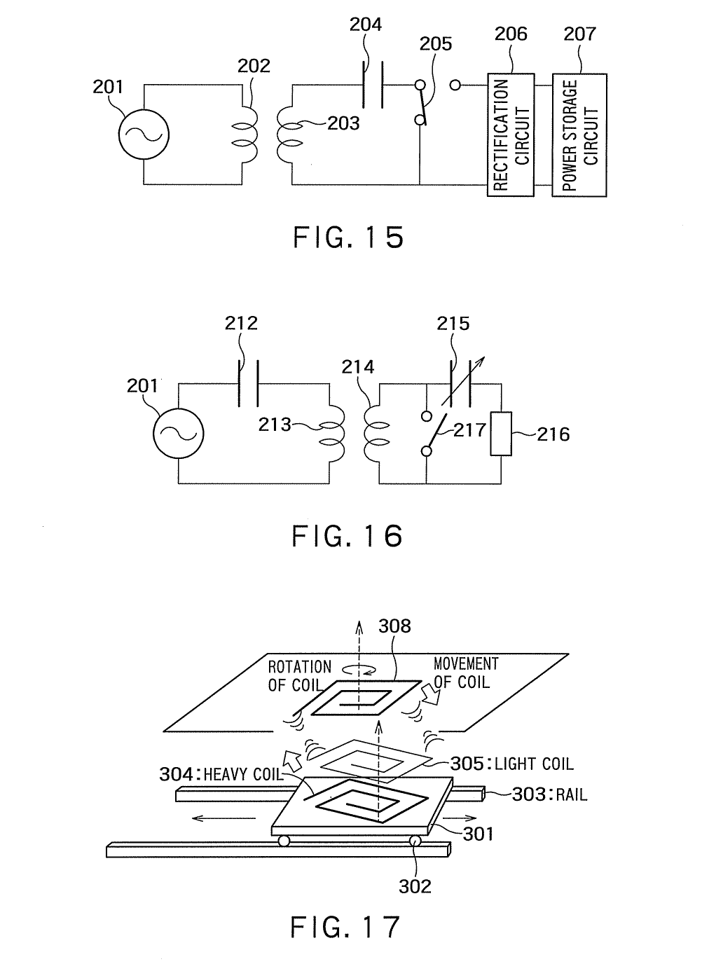

FIG. 15 illustrates part of a wireless power transmission system configuration according to the present embodiment. Illustration of a communication circuit, a mode switching unit and an impedance controller, and so on, is omitted.

A power transmission circuit includes an alternating-current signal source 201 of fixed frequency and a power transmission inductor 202.

A power reception circuit includes a power reception inductor 203, a capacitor 204, a switch 205, a rectification circuit 206 and a power storage circuit 207. One end of the capacitor 204 is connected with the power reception inductor 203 and the connection destination of another end of the capacitor 204 can be switched between another end of the power reception inductor 203 and the rectification circuit 206 by the switch 205. The switch 205 can be controlled by an unillustrated impedance controller or mode switching unit.

At the time of the alignment mode, by connecting the other end of the capacitor 204 to the other end of the power reception inductor 203, an impedance condition for alignment is generated. In this state, alternating-current power is supplied from the alternating-current signal source on the power transmission side, alignment is performed and the relative distance between the power transmission inductor and the power reception inductor is shortened. At this time, the other end of the inductor 203 may be connected with the ground to discard received power.

At the time of the power transmission mode, the other end of the capacitor 204 is connected with the rectification circuit 206. As a result of this, an impedance condition for the power transmission mode is generated. Under this state, wireless power transmission is performed. Alternating-current power received on the power reception side is rectified in the rectification circuit 206 and direct-current power is supplied to the power storage circuit 207. The power storage circuit 207 internally accumulates the supplied power. A load to consume power may be arranged instead of the power storage circuit 207.

FIG. 16 illustrates part of another configuration of the wireless power transmission system according to the present embodiment.

A power transmission circuit includes an alternating-current signal source 211 of fixed frequency, a capacitor 212 and a power transmission inductor 213.

A power reception circuit includes a power reception inductor 214, a variable-capacity capacitor 215, a load 216 and a switch 217.

At the time of a power transmission mode and an alignment mode, wireless power transmission is performed in a state where the switch 217 is turned off. The impedance condition is changed by changing the value of the variable-capacity capacitor 215.

Here, in a case where a predetermined abnormal state is caused, the switch 217 is turned on and both ends of the power reception inductor 214 are connected so that the repulsive force is generated between both inductors. As a result of this, the inductors are separated from each other. As a result of this, the coupling coefficient decreases, the transmission stops or the transmission efficiency decreases. The predetermined abnormal state includes that the temperature of the power transmission apparatus or power reception apparatus, the value of transmission power, an external force, the reception power or the distance between the inductors exceeds a respective threshold, and includes invasion of foreign objects and electrical leakage. As a detection method of the predetermined abnormal state, a configuration is possible in which a sensor is arranged in the power transmission apparatus or the power reception apparatus and the mode switching unit or the controller detects the abnormal state on the basis of the output of the sensor. In this case, when detecting the predetermined abnormal state, the mode switching unit or the controller performs operation to turn on the switch 217.

### Fifth Embodiment

FIG. 17 is a schematic diagram of a wireless power transmission system according to the present embodiment.

A wheel 302 is arranged on the lower surface of a substrate 301 in a power transmission apparatus and can move on a rail 303 by a three-axis actuator of x, y and θ, two-axis actuator or one-axis actuator, and so on. On the surface of the substrate 301, a power transmission circuit including a heavy coil (power transmission coil) 304 as a power transmission inductor and a sensor for alignment (not illustrated) are arranged. A light coil 305 is arranged so as to face the heavy coil 304.

In a power reception apparatus, a power reception circuit including a power reception inductor (power reception coil) 308 is arranged on an upper surface or lower surface of a ground plane 309.

The substrate 301 is moved on the rail 303, and alignment (rough alignment) of the light coil 305 and the power reception coil 308 is performed using a sensor for alignment. For example, by irradiating an electromagnetic wave or the like from sensor 307 and measuring its reflected wave, it is possible to perform position detection of the power reception coil 308. When the rough alignment is performed, alignment between the power reception coil 308 and the light coil 305 is performed by any of the alignment techniques described above. After the alignment, wireless power transmission is performed between the heavy coil 304 and the power reception coil 308 through the light coil 305. The light coil 305 is movable only within a range defined in advance with respect to the heavy coil 304, and the light coil 305 and the heavy coil 304 can perform efficient power transmission in this range. Alternatively, the position of the light coil 305 may be fixed and the heavy coil 304 may be aligned with the light coil 305 by any of the above-mentioned techniques.

According to the technique of the present embodiment, it is possible to eliminate an actuator or sensor with high accuracy and eliminate an actuator with a large number of axes. Moreover, even if the distance between the power reception coil 308 and the heavy coil 304 is large, it becomes easy to perform alignment by interposing the light coil (the magnitude of attractive force or repulsive force becomes small when the distance is large).

As a variation example of the present embodiment, the user may manually move a power transmission apparatus and perform inductor alignment according to the present technique after confirming that the power transmission apparatus is in a predetermined available range. For example, the power transmission apparatus is moved in a state where a light receiving element is arranged on the power reception apparatus side, a light source is arranged on the power transmission apparatus side and the light source is caused to emit light. When the light receiving element emits light, the user determines that it is within the predetermined available range, and the power transmission apparatus is fixed to the place to instruct the power transmission apparatus or the power reception apparatus to execute the present technique.

### Sixth Embodiment

FIG. 18 is a schematic diagram of a wireless power transmission system according to the present embodiment.

In a power transmission apparatus, a power transmission circuit including a power transmission inductor (power transmission coil) 402 is arranged in a surface of a substrate 401. The substrate 401 is placed on a ground plane 403. A plurality of emission holes 404 to eject liquid or gas to a back surface of the substrate 401 are formed on the ground plane 403. An emitting unit to eject liquid or gas from the emission holes 404 is arranged in the back surface of the ground plane 403. The emitting unit is one example of an adjusting unit that suppresses the movement of an inductor or that facilitates the movement.

In a power reception apparatus, a power reception circuit including a power reception inductor (power reception coil) 408 is arranged on an upper surface or lower surface of a ground plane 409.

In the present embodiment, alignment between the power transmission coil and the receipt coil is performed in a state where the liquid or gas is emitted from the emission holes 404 to reduce a friction coefficient between the substrate 401 and the ground plane 403. Here, the power transmission coil is fixed to the substrate 401 and the substrate 401 moves in the alignment. As a result of this, it is possible to perform alignment in a state where the friction coefficient between the substrate 401 and the ground plane 403 is reduced to facilitate the substrate 401 to move. After the alignment ends, the emission of the liquid or gas is stopped and power transmission is started. At the time of power transmission, the position shift of the substrate 401 is suppressed by the friction coefficient between the substrate 401 and the ground plane 403, and stable power transmission becomes possible.

Although an alignment configuration of the power transmission inductor has been illustrated in the example illustrated in FIG. 18, a similar configuration may be applied for the power reception inductor. The same applies to the present embodiment and other embodiment examples described below.

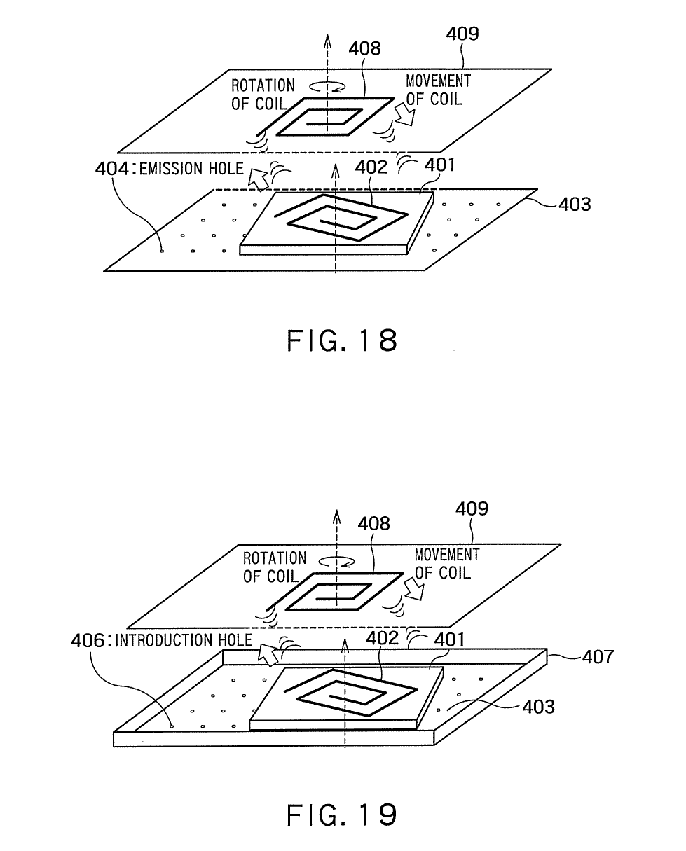

FIG. 19 is a schematic diagram of another example of the wireless power transmission system according to the present embodiment. A wall 407 is formed along each edge side of the ground plane 403 and introduction holes 406 are formed on the ground plane 403. An injecting unit to inject liquid from the introduction holes 406 is arranged on the back surface of the ground plane 403. The injecting unit is one example of an adjusting unit that suppresses the movement of an inductor or facilitates the movement.

The liquid is emitted from the introduction holes 406 by a constant amount or for a fixed time, and the liquid is saved in a container formed by the ground plane 403 and the wall 407. By the liquid in the container, a lower part of the substrate 401 on which a power transmission coil is put enters a state where it is soaked by the liquid, and the friction coefficient between the substrate 401 and the ground plane 403 is decreased. In this state, alignment is performed. As a result of this, it is possible to perform alignment in a state where the substrate 401 is facilitated to move. After the alignment ends, the liquid in the container is drained out from the introduction holes 406 to increase the friction coefficient between the substrate 401 and the ground plane 403. In this state, power transmission is started. At the time of power transmission, the position shift of the substrate 401 is suppressed and stable power transmission becomes possible.

Here, although the inductor is arranged on the substrate 401 in the example illustrated in FIG. 19, the inductor may be directly arranged on the ground plane 403.

### Seventh Embodiment

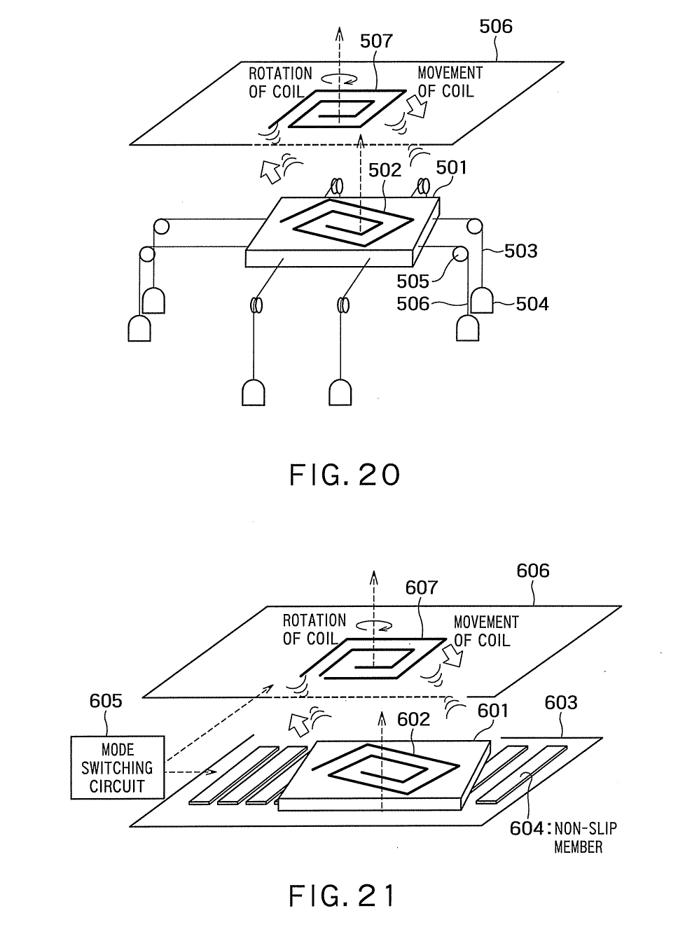

FIG. 20 is a schematic diagram of a wireless power transmission system according to the present embodiment.

In a power reception apparatus, a power reception circuit including a power reception inductor (power reception coil) 507 is arranged in an upper surface or lower surface of a ground plane 506.

In a power transmission apparatus, a power transmission circuit including a power transmission inductor (power transmission coil) 502 is arranged on a surface of a substrate 501. The substrate 501 is supported in the air by a plurality of supporting units (adjusting units). Each supporting unit includes a string 506, a pulley 505 and a weight 504. One end of each string is fixed to a side surface of the substrate 501 and the weight 504 is attached to another end thereof. Each string is put on the pulley 505 on the way, and, when each weight 504 pulls the substrate 501 in four directions by gravity, the substrate 501 is thereby supported in the air. Each pulley has a certain width in a part on which the string is put, and the string is movable within this range. By control from the outside, each pulley can enter a state where the rotation is facilitated (or rotatable) and a state where the rotation is fixed (or unrotatable).

Each pulley is entered into a state where the rotation is facilitated at the time of alignment, and the alignment between the power transmission coil and the power reception coil is performed. As a result of this, the movement of the substrate 501 is facilitated. When the alignment ends, each pulley is fixed. By performing power transmission in this state, it is possible to perform stable power transmission in which the position shift of the substrate 501 is suppressed.

### Eighth Embodiment

FIG. 21 is a schematic diagram of a wireless power transmission system according to the present embodiment.

In a power reception apparatus, a power reception circuit including a power reception inductor (power reception coil) 607 is arranged on an upper surface or lower surface of a ground plane 606.

In a power transmission apparatus, a power transmission circuit including a power transmission inductor (power transmission coil) 602 is arranged in a surface of a substrate 601. The substrate 601 is put on a ground plane 603. A strip-shaped groove is formed on the surface of the ground plane 603 and a non-slip member 604 is arranged along the shape of the groove. A mode switching circuit 605 controls an adjusting unit that adjusts the non-slip member 604 to be embedded in a state where it is lower than the surface of the ground plane 603 and in a state where it is projected from the surface of the ground plane 603. In a state where it is projected from the surface of the ground plane 603, the non-slip member 604 contacts a back surface of the substrate 601, and thereby it is possible to increase the friction coefficient on the back surface of the substrate 601. As the non-slip member, for example, it is possible to use a material with a high friction coefficient such as a rubber and a material with concavity and convexity on the surface, and so on. Here, as other methods than the method of using the non-slip member, it is considered to fix a position of the substrate 601 by generating an electric field or a magnetic field.

At the time of alignment, the non-slip member is entered into a state where it is embedded under the ground plane 603. Since the friction coefficient on the back surface of the substrate 601 decreases by performing alignment in this state, the substrate 601 becomes easy to move and the alignment is facilitated. When the alignment ends, the non-slip member is projected from the surface of the ground plane 603 to increase the friction coefficient on the back surface of the substrate 601. By performing power transmission in this state, position shift of the substrate 601 is suppressed and stable power transmission becomes possible.

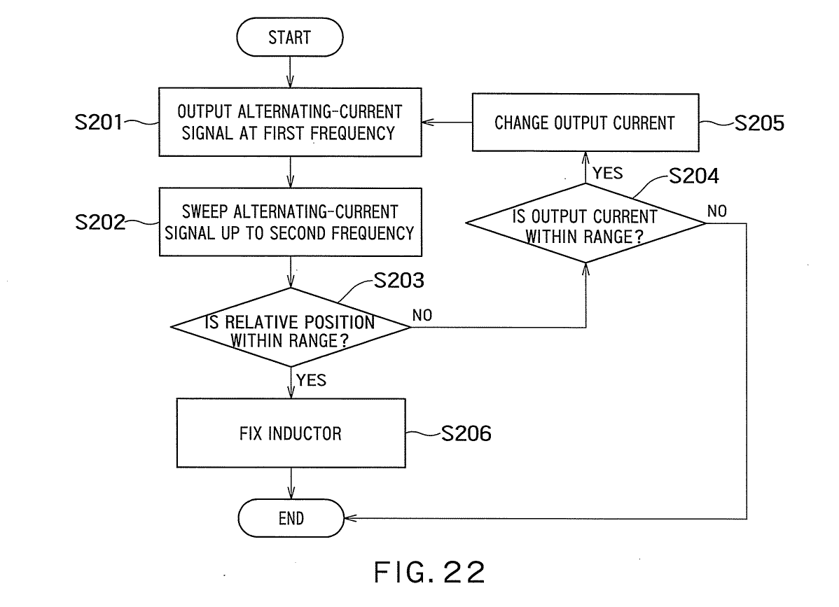

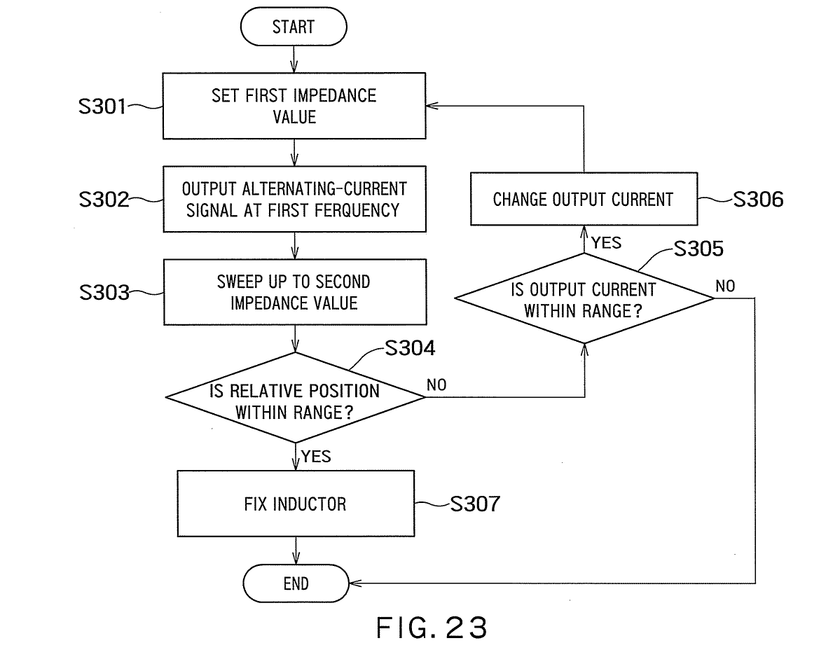

FIG. 22 and FIG. 23 illustrate flows in which processing to fix the position of a coil (here, a power transmission coil is assumed but a power reception coil is also possible) at the end time of alignment is added. In these figures, steps S206 and S307 in which the position of the inductor (coil) is fixed are added to FIG. 13 and FIG. 14, respectively. A similar step may be added after step S103 in FIG. 7. The processing other than the steps are similar to those of FIG. 13 and FIG. 14, and therefore the explanation is omitted. The flows in FIG. 22 and FIG. 23 are applicable to that of the sixth embodiment described above.

### Ninth Embodiment

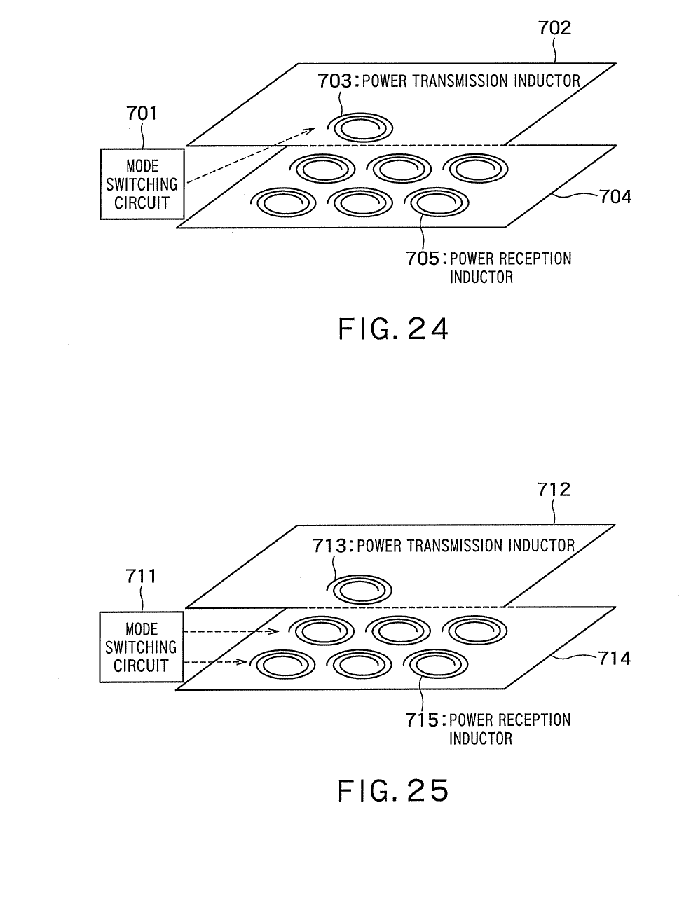

FIG. 24 is a schematic diagram of a wireless power transmission system according to the present embodiment.

A power reception circuit including a plurality of power reception inductors 705 is arranged in a ground plane 704. The position of each power reception inductor 705 is fixed. A power transmission circuit including at least one power transmission inductor 703 is arranged in a ground plane 702 on the power transmission side. When an alignment mode is executed in a mode switching unit 701, the power transmission inductor 703 is autonomously aligned with one of the plurality of power reception inductors 705. For example, it is drawn to a power reception inductor on which the attractive force acts the most.

FIG. 25 is a schematic diagram of another configuration example of the wireless power transmission system according to the present embodiment.

A power reception circuit including a plurality of power reception inductors 715 is arranged in a ground plane 714. Each power reception inductor 715 is movable on the ground plane 714 at the time of alignment. A power transmission circuit including a power transmission inductor 713 is arranged in a ground plane 712 on the power transmission side. The position of the power transmission inductor 713 is fixed. When the alignment mode is executed by a mode switching unit 711, one of the plurality of power reception inductors 715 is autonomously aligned with the power reception inductor 713. For example, a power reception inductor on which the attractive force acts most is drawn to the power transmission inductor 713. Here, instead of all of the plurality of power reception inductors 715, two or more arbitrary power reception inductors (for example, N power reception inductors with the shortest distance to the power transmission inductor) may be set to the alignment mode.

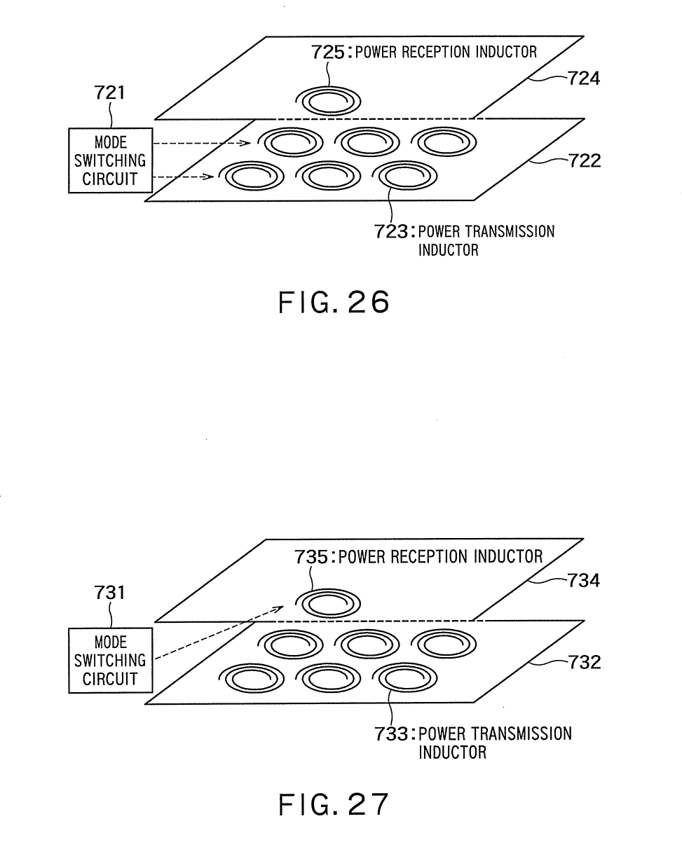

FIG. 26 is a schematic diagram of another configuration example of the wireless power transmission system according to the present embodiment.

A power reception circuit including a power reception inductor 725 is arranged in a ground plane 724. The position of the power reception inductor 725 is fixed. A power transmission circuit including a plurality of power transmission inductors 723 is arranged in a ground plane 722 on the power transmission side. Each power transmission inductor 723 is movable on the ground plane 722 at the time of alignment. When the alignment mode is executed by a mode switching unit 721, one of the plurality of power transmission inductors 722 is autonomously aligned with the power reception inductor 725. For example, a power transmission inductor on which the attractive force acts most is drawn to the power reception inductor 725. Here, instead of all of the plurality of power transmission inductors 723, two or more arbitrary power transmission inductors (for example, N power transmission inductors with the shortest distance to the power reception inductor) may be set to the alignment mode.

FIG. 27 is a schematic diagram of another configuration example of the wireless power transmission system according to the present embodiment.

A power reception circuit including a power reception inductor 735 is arranged in a ground plane 734. The power reception inductor 735 is movable on the ground plane 734 at the time of alignment. A power transmission circuit including a plurality of power transmission inductors 733 is arranged in a ground plane 732 on the power transmission side. The position of each power transmission inductor 733 is fixed. When the alignment mode is executed by the mode switching unit 721, the power reception inductor 735 is autonomously aligned with one of the plurality of power transmission inductors 733. For example, the power reception inductor 735 is drawn to the power transmission inductor 733 on which the attractive force acts most.

### Tenth Embodiment

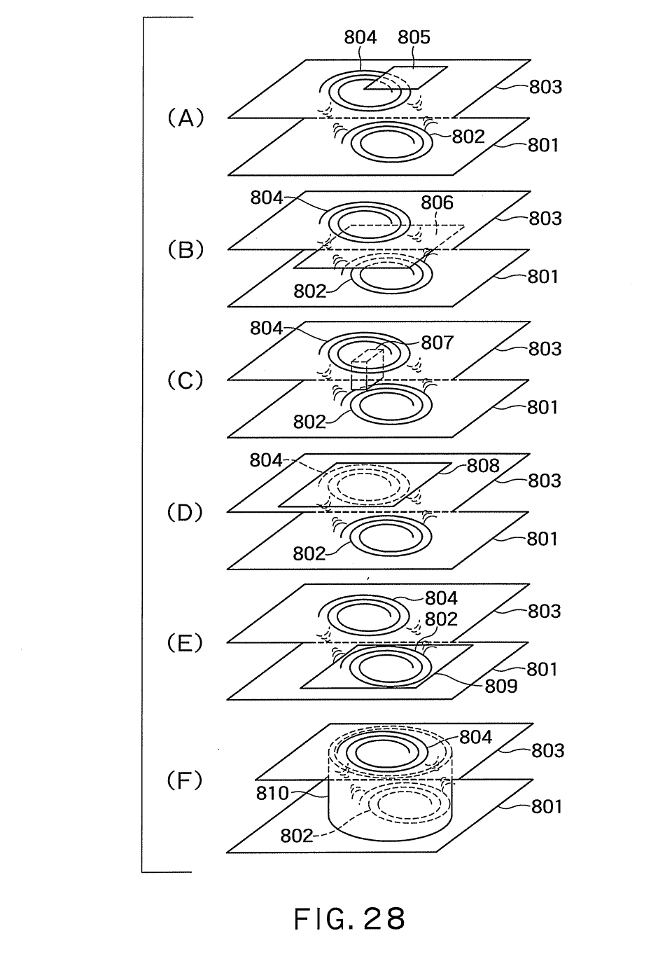

FIG. 28(A), FIG. 28(B), FIG. 28(C), FIG. 28(D), FIG. 28(E) and FIG. 28(F) illustrate examples of a wireless power transmission system according to the present embodiment. In each figure, a magnetic material whose permeability is higher than air is arranged in a power transmission inductor or power reception inductor. As a magnetic material, for example, it is possible to use ferrite. It is possible to increase the attractive force or repulsive force by making coupling coefficient k higher by arranging the magnetic material.

In FIG. 28(A), a power transmission circuit including a power transmission inductor 802 is arranged in a ground plane 801 and a power reception circuit including a power reception inductor 804 is arranged in a ground plane 803. In this example, a magnetic material 805 is arranged so as to face an upper surface of part of wiring of the power reception inductor 804. Here, a magnetic material may be arranged so as to face a side surface of the wiring.

In FIG. 28(B), a magnetic material 806 is arranged between the power reception inductor 804 and the power transmission inductor 802. Other components are the same as those of FIG. 28(A). The magnetic material 806 may be included in either the power transmission apparatus side or the power reception apparatus side, or may independently exist between both apparatuses.

In FIG. 28(C), a magnetic material 807 is arranged inside the power reception inductor 804. Other components are the same as those of FIG. 28(A).

In FIG. 28(D), a magnetic material 808 is arranged so as to cover a surface on the opposite side to the power transmission inductor 802 in both surfaces of the power reception inductor 804. Other components are the same as those of FIG. 28(A).

In FIG. 28(E), a magnetic material 809 is arranged between the power transmission inductor 802 and the ground plane 801. Other components are the same as those of FIG. 28(A).

In FIG. 28(F), a hollow pillar-shaped magnetic material 810 is arranged so as to include both the power reception inductor 804 and the power transmission inductor 802. Other components are the same as those of FIG. 28(A).

### Eleventh Embodiment

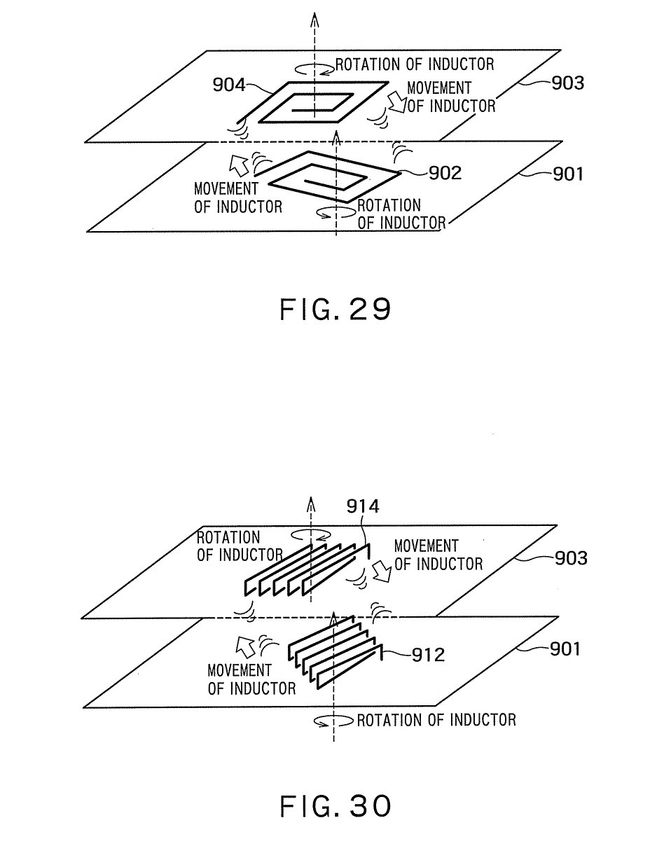

FIG. 29 illustrates an example of a wireless power transmission system according to the present embodiment.

A power transmission circuit including a power transmission inductor 902 is arranged in a ground plane 901 and a power reception circuit including a power reception inductor 904 is arranged in a ground plane 903. The power transmission inductor 902 and the power reception inductor 904 have a non-rotationally symmetrical planar shape like an oval and a polygon.

By aligning such inductors, not only alignment in the x, y and z directions but also alignment in the B direction (rotation direction) are self-aligned.

FIG. 30 illustrates an example of the wireless power transmission system according to the present embodiment. Another example of a non-rotationally symmetrical planar shape is illustrated as the shape of a power transmission inductor 912 and a power reception inductor 914. The others are similar to the configuration in FIG. 29.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A control apparatus for a first wireless power transmission apparatus and a second wireless power transmission apparatus, the first wireless power transmission apparatus including a first inductor and an alternating-current signal source that supplies an alternating-current power to the first inductor, and the second wireless power transmission apparatus including a second inductor that receives the alternating-current power wirelessly from the first inductor, comprising:
a position controller which controls a phase relationship of current flowing in the first inductor and the second inductor such that attractive force or repulsive force is generated between the first and second inductors, and adjusts a relative position of the first inductor and the second inductor by use of the attractive force or the repulsive force.

2. The control apparatus according to claim 1,
wherein the position controller controls the phase relationship by changing at least one of an oscillation frequency of the alternating-current signal source and an impedance value of a second circuit including the second inductor.

3. The control apparatus according to claim 2,
wherein the position controller sweeps at least one of the oscillation frequency of the alternating-current signal source and the impedance value of the second circuit in a certain range.

4. The control apparatus according to claim 3,
wherein the position controller confirms whether the relative position is within a predetermined range after the sweep is performed, and, in a case where the relative position is not within the predetermined range, repeats the sweep again.

5. The control apparatus according to claim 4,
wherein, when performing the sweep again, the position controller makes a speed of the sweep slower than a speed at a previous sweep.

6. The control apparatus according to claim 4,
wherein, when performing the sweep again, the position controller makes an output of the alternating-current signal source larger than an output at a previous sweep.

7. The control apparatus according to claim 3,
wherein the position controller sweeps the oscillation frequency from a frequency near a resonance frequency of a first circuit including the first inductor or the second circuit to a first frequency larger than the frequency, or sweeps the oscillation frequency from a second frequency smaller than the resonance frequency to the frequency near the resonance frequency larger than the second frequency.

8. The control apparatus according to claim 3,
wherein the position controller controls a speed of the sweep so as to prevent a differential value of current flowing in a first circuit including the first inductor or a differential value of current flowing in the second circuit including the second inductor from becoming a negative value.

9. The control apparatus according to claim 1,
wherein the position controller moves the first inductor or the second inductor by driving an actuator to pre-adjust the relative position of the first and second inductors and thereafter controls the phase relationship to adjust the relative position of the first inductor and the second inductor.

10. The control apparatus according to claim 1,
wherein the position controller detects a position relationship between the first and second inductors using a sensor, notifies the position relationship that is detected to a user, and, after the position relationship between the first and second inductors is pre-adjusted by the user, controls the phase relationship to adjust the relative position of the first inductor and the second inductor.

11. The control apparatus according to claim 1,
wherein:
the position controller controls an adjusting unit that suppresses a movement of the first inductor or the second inductor or facilitates the movement; and
the position controller adjusts the relative position of the first inductor and the second inductor by controlling the phase relationship in a state where the movement of the first inductor or the second inductor is facilitated by the adjusting unit, and, after the adjustment, suppress the movement of the first inductor or the second inductor by the adjusting unit.

12. The control apparatus according to claim 11,
wherein the adjusting unit includes an emitting unit configured to emit at least one of liquid and gas to a back surface of a substrate mounting one of the first inductor or the second inductor, and
the position controller facilitates a movement of the substrate by emitting at least one of the liquid and the gas to the back surface of the substrate and suppresses the movement of the substrate by stopping the emission.

13. The control apparatus according to claim 11,
wherein the adjusting unit includes an injecting unit configured to inject liquid in a container housing a substrate mounting one of the first inductor or the second inductor, and
the position controller facilitates a movement of the substrate by injecting the liquid in the container to soak the substrate in the liquid, and suppresses the movement of the substrate by draining the liquid in the container out to an outside.

14. The control apparatus according to claim 11,
wherein the adjusting unit includes a supporting unit supporting a substrate by putting a plurality of strings on a plurality of pulleys arranged correspondingly to a plurality of side surfaces of the substrate, one end of each string being coupled with a weight and another end of each string being coupled with one of the side surfaces of the substrate, the substrate mounting one of the first inductor or the second inductor and
the position controller suppresses a movement of the substrate by fixing rotation of the pulleys in the supporting unit and facilitates the movement of the substrate by facilitating the rotation of the pulleys.

15. The control apparatus according to claim 11,
wherein the adjusting unit causes a member with a high friction coefficient to contact a back surface of a substrate mounting one of the first or second inductor, and
the position controller suppresses a movement of the substrate by controlling to cause the member to contact the back surface of the substrate and facilitates the movement of the substrate by separating the member from the back surface of the substrate.

16. A wireless power transmission system comprising:
a first wireless power transmission apparatus including a first inductor and an alternating-current signal source that supplies an alternating-current power to the first inductor;
a second wireless power transmission apparatus including a second inductor that receives the alternating-current power wirelessly from the first inductor; and
a controlling apparatus which controls a phase relationship of current flowing in the first inductor and the second inductor such that attractive force or repulsive force is generated between the first and second inductors, and adjusts a relative position of the first inductor and the second inductor by use of the attractive force or the repulsive force.

17. The system according to claim 16, comprising:
a magnetic material arranged near wiring of the first inductor or the second inductor, having permeability higher than air.

18. The system according to claim 16, wherein
the first inductor or the second inductor has a non-rotationally symmetrical shape.

19. A wireless power transmission apparatus comprising:
an alternating-current signal source that supplies an alternating-current power;
an inductor transmitting the alternating-current power to an inductor of another wireless power transmission apparatus wirelessly; and
a position controller which controls a phase relationship of current flowing in the inductor and the inductor of said other wireless power transmission apparatus such that attractive force or repulsive force is generated between the inductor and the inductor of said other wireless power transmission apparatus, and adjusts a relative position of the inductor and the inductor of said other wireless power transmission apparatus by use of the attractive force or the repulsive force.

20. A wireless power transmission apparatus comprising:
an inductor receiving alternating-current power from an inductor of another wireless power transmission apparatus wirelessly; and
a position controller which controls a phase relationship of current flowing in the inductor and the inductor of said other wireless power transmission apparatus such that attractive force or repulsive force is generated between the inductor and the inductor of said other wireless power transmission apparatus, and adjusts a relative position of the inductor and the inductor of said other wireless power transmission apparatus by use of the attractive force or the repulsive force.
